(19) United States
(12) Patent Application Publication
(10) Pub. No.: US 2010/0147279 A1
(43) Pub. Date: Jun. 17, 2010

(54) CUTTING TOOL, PARTICULARLY FOR STONE MATERIALS AND THE LIKE

(75) Inventors: Mauro Baraldi, Sassuolo (IT); Werner Ricclolinl, Isola Vicentina (IT)

Correspondence Address: STRADLEY RONON STEVENS & YOUNG, LLP, 30 VALLEY STREAM PARKWAY, GREAT VALLEY CORPORATE CENTER, MALVERN, PA, 19355-1481, US

(73) Assignee: ADI S.p.A., Thiene (IT)

(21) Appl. No.: 12/531,525

(22) PCT Filed: Mar. 10, 2008
(86) PCT No.: PCT/EP2008/052828

§ 371 Date: Sep. 16, 2009

(30) Foreign Application Priority Data
Mar. 16, 2007 (IT) PD2007A000097

(51) Int. Cl. B28D 1/04; B28D 1/12

(52) U.S. Cl. 125/15; 125/22

(57) ABSTRACT

A tool for cutting stone materials, porcelaneous stoneware, glass and the like. The tool includes a support having a transverse thickness with respect to the direction of cutting and abrasive segments attached to the support and made from a mixture of abrasive material and binder. The segments are positioned in sequence along a cutting edge of the support, project from the support, and define a first and a second plurality of segments. One or more segments of the first plurality alternate with one or more segments of the second plurality in sequences which are repeated along the cutting edge. The segments of the first plurality have a greater thickness than the segments of the second plurality, and the abrasive material from which the segments of the first plurality are formed has a smaller particle size than the abrasive material from which the segments of the second plurality are formed.

### TECHNICAL FIELD

The present invention relates to a cutting tool for stone materials, porcelaneous stoneware, glass and other materials.

### TECHNOLOGICAL BACKGROUND

The invention is particularly applicable to the field of cutting where use is made of tools such as rotating discs provided with abrasive segments, typically formed from diamond powders mixed with binders such as powdered metals or the like.

The invention is particularly intended for use with cutting discs, although the essential inventive concepts of the invention can also be applied to cutting tools of the blade type.

In this field, there are known technical solutions which provide cutting edges of tools having a plurality of abrasive segments spaced at angular intervals, with a transverse thickness greater than the thickness of the support, to enable the segment to penetrate into the material to be cut, without any interference with the support to which the segments are attached.

There are also known solutions which provide repeated sequences of abrasive segments projecting along the cutting edge, in which the segments in the sequence have different heights and/or widths, which may for example increase or decrease in the direction in which the tool cuts, this configuration providing a greater penetrating capacity and a greater ease of expulsion and discharge of the dust of abraded material formed in the cutting operation.

In this field, in the case of certain materials such as glazed porcelaneous stoneware tiles, it has been found necessary to achieve a suitable quality of surface finish during the cutting operation itself, especially on the surfaces abraded by the tool during cutting and along the edges adjacent to the cut.

### SUMMARY DISCLOSURE OF THE INVENTION

A principal object of the invention is to provide a cutting tool capable of meeting the aforesaid requirements while overcoming the limitations of the known solutions.

This object and others which are described more fully below are achieved by the invention by providing a cutting tool for cutting stone materials, porcelaneous stoneware, glass and the like in a direction of cutting. The tool includes a support having a transverse thickness with respect to the direction of cutting and a cutting edge; and abrasive segments attached to the support and made from a mixture of abrasive material and binder. The segments are positioned in sequence along the cutting edge of the support, project from the support, and have a first and a second plurality of segments in which one or more segments of the first plurality alternate with one or more segments of the second plurality in sequences which are repeated along the cutting edge. The segments of the first plurality are thicker than the segments of the second plurality, and the abrasive material from which the segments of the first plurality are formed has a smaller particle size than the abrasive material from which the segments of the second plurality are formed.

It is to be understood that both the foregoing general description and the following detailed description are exemplary, but are not restrictive, of the invention.

### BRIEF DESCRIPTION OF THE DRAWINGS

Other features and advantages of the invention will become clear from the following detailed description of preferred examples of embodiments thereof, illustrated, for the purpose of illustration and in a non-limiting way, in the attached drawings, in which:

FIG. 1 is a perspective view of a cutting tool made according to the invention;

FIG. 2 is a partial view on an enlarged scale of a detail of the tool of the preceding figure;

FIG. 3 is a view corresponding to that of FIG. 2, in a variant embodiment of the invention; and

FIGS. 4 and 5 are views corresponding to that of FIG. 2, of corresponding additional variant embodiments of the invention.

### PREFERRED EMBODIMENTS OF THE INVENTION

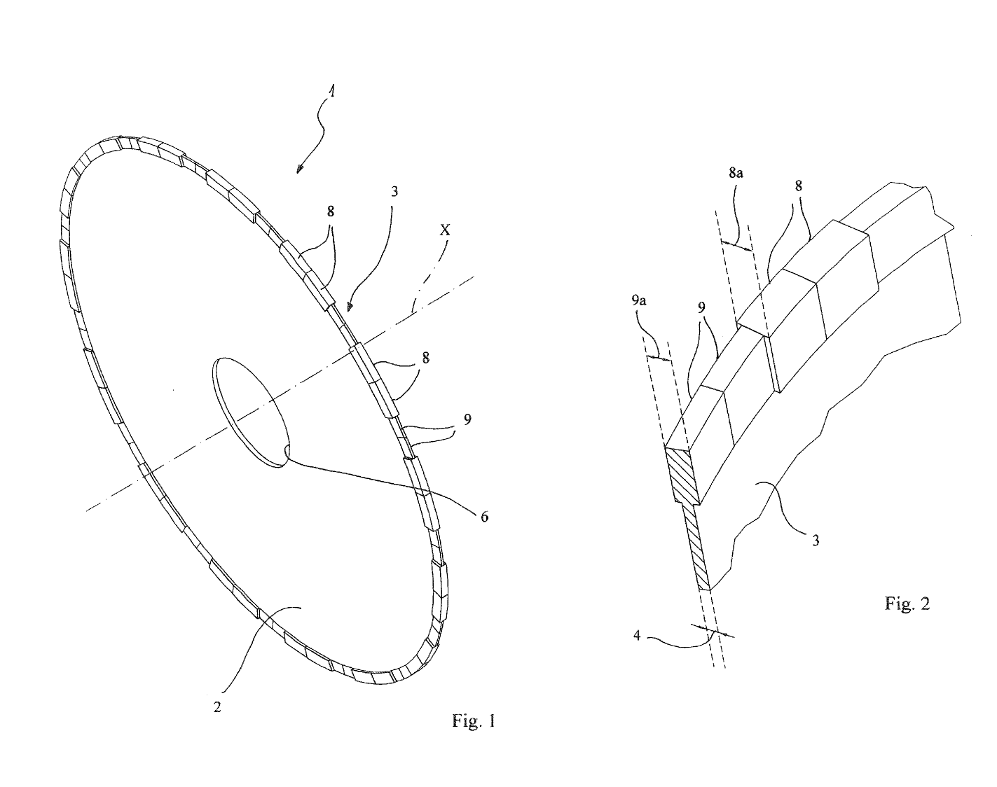

With reference to FIG. 1 initially, the number 1 indicates the whole of a cutting tool made according to the present invention.

The tool 1 is shaped in the form of a cutting disc and comprises an axially symmetrical disc-shaped support 2, having a principal axis indicated by X in the drawings, and carrying a circumferential edge 3, to which abrasive cutting segments are attached.

The number 4 indicates the transverse thickness of the disc at the edge 3, measured parallel to the axis X.

The support 2 is designed with a central hole 6 for attachment to a drive shaft (not shown) intended to cause the disc to rotate in cutting operations, the direction of cutting being positioned tangentially to the circumferential edge 3.

The tool 1 also comprises a first and a second plurality of abrasive segments, the segments of each plurality being indicated by 8 and 9 respectively, these segments being attached to the support 2 at the edge 3 and projecting radially from the support 2, in a predetermined configuration providing a repetition of sequences in which segments 8 alternate with segments 9.

In a preferred configuration (FIG. 2), the sequence repeated along the edge 3 comprises a pair of segments 8, adjacent to a pair of segments 9, all the segments being aligned circumferentially along the edge 3. It is also specified that the aforesaid sequence is repeated with a constant angular interval along the edge 3, as is clearly shown in FIG. 2.

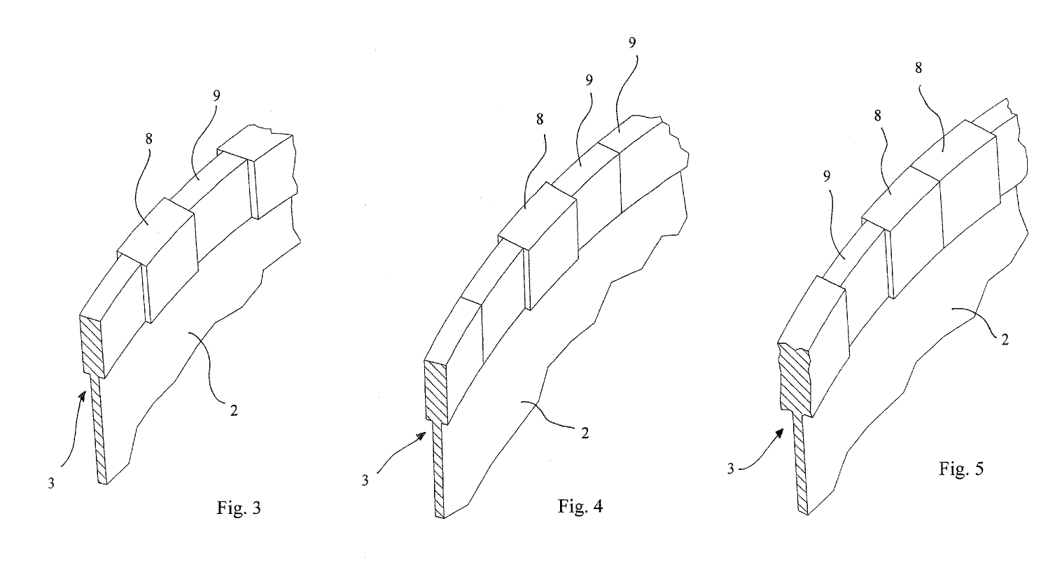

Alternatively, it is possible to provide a sequence comprising a segment 8 adjacent to a segment 9, the segments being aligned circumferentially along the edge 3 (FIG. 3), or, as a further alternative, it is possible to provide a sequence in which a pair of segments 8 or 9 is placed adjacent to a single segment 9 or 8 (FIGS. 4 and 5). FIGS. 2 to 5 show the sequences described above, although it is to be understood that other configurations of sequences of segments 8 and 9 are possible, according to the specific requirements encountered in the cutting of certain materials.

Returning to the configuration of FIG. 2, according to a principal characteristic of the invention, it is specified that the thickness of the segments 8, indicated by 8a, is greater than the thickness 9a of the segments 9, both of these values being measured parallel to the principal axis X. It is also specified that the material selected for making the segments 8 of the first plurality has a smaller particle size than that of the material from which the segments 9 of the second plurality are formed. In this case, it is specified that the abrasive material of each segment is formed from a mixture of an abrasive material and a binder, the aforementioned particle size relating to the abrasive material only (in most cases, the abrasive material used is industrial diamond).

A preferable option is to make the thickness 8a of the segments 8 a few tenths of a millimeter (for example, about 0.1 mm) greater than the thickness 9a of the segments 9.

Each abrasive segment 8, 9 is preferably made by a sintering process and is fixed to the support 2 by welding, particularly by braze welding or laser welding.

Because of the aforementioned features, the segments 9 are primarily required to carry out the actual cutting function, and are therefore conveniently formed from materials having a larger particle size, for greater cutting efficiency, while the segments 8, having a greater thickness and smaller particle size, are primarily required to carry out the surface finishing function during the cutting operation. Consequently the two functions are integrated and carried out during the operation of cutting the material, thus efficiently providing the aforementioned dual action.

It has been found that this effect of improved surface finishing obtained simultaneously with the cutting operation is particularly desirable in the cutting of stone materials or glazed porcelaneous stoneware, where it is important to avoid invasive fractures of the glaze while still limiting the processing time, which in turn requires the use of very large diamond particle sizes (the particle size of the diamond used in the segments is increased in order to increase the cutting power of the tool).

Thus the invention achieves the proposed objects while yielding the aforementioned advantages by comparison with the known solutions.

Although illustrated and described above with reference to certain specific embodiments and examples, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges.

1. A tool for cutting stone materials, porcellaneous stoneware, glass and the like in a direction of cutting, the tool comprising:
a support having a transverse thickness with respect to the direction of cutting and a circumferential cutting edge; and
abrasive segments attached to the support and made from a mixture of abrasive material and binder, the segments being positioned in sequence along the cutting edge of the support and projecting from the support, the segments having a first and a second plurality of segments in which one or more segments of the first plurality alternate with one or more segments of the second plurality in sequences which are repeated along the cutting edge, the segments of the first plurality are thicker than the segments of the second plurality, and the abrasive material from which the segments of the first plurality are formed has a smaller particle size than the abrasive material from which the segments of the second plurality are formed.

2. The tool according to claim 1, in which the segments of the first and the second plurality have corresponding thicknesses which are greater than the thickness of the support.

3. The tool according to claim 1, shaped in the form of a cutting disc.

4. The tool according to claim 3, in which the support is disc-shaped and the segments of the pluralities are attached in sequence along the circumferential cutting edge of the support.

5. The tool according to claim 1, in which the segments are attached to the support by braze welding or laser welding.

6. The tool according to claim 1, in which the repeated sequence of segments along the cutting edge includes a segment of the first plurality positioned adjacent to a segment of the second plurality, all the segments of the sequence being aligned along the edge in the direction of cutting.

7. The tool according to claims 1, in which the repeated sequence of segments along the cutting edge includes a pair of adjacent segments of the first plurality located adjacent to a pair of segments of the second plurality, all the segments of the sequence being aligned along the edge in the direction of cutting.

8. The tool according to claim 1, in which the repeated sequence of segments along the edge includes a segment of one of the pluralities adjacent to a pair of segments of the other of the pluralities of segments, all the segments of the sequence being aligned along the edge in the direction of cutting.

9. The tool according to claim 1, in which the abrasive material of the pluralities of segments comprises diamond powders.

10. The tool according to claim 1, in which the binder of the pluralities of segments comprises powdered metals.

11. The tool according to claim 10, in which the powdered metals of the segments of the first plurality have a different composition from that of the powdered metals of the segments of the second plurality.

12. The tool according to claim 10, in which the powdered metals of the segments of the first plurality have a different particle size from that of the powdered metals of the segments of the second plurality.

13. A tool for cutting stone materials, porcelaneous stoneware, glass and the like in a direction of cutting, the tool comprising:
a disc-shaped support having a transverse thickness with respect to the direction of cutting and a circumferential cutting edge; and
abrasive segments attached to the support and made from a mixture of abrasive material and binder, the segments being positioned in sequence along the cutting edge of the support and projecting from the support, the segments having a first and a second plurality of segments in which one or more segments of the first plurality alternate with one or more segments of the second plurality in sequences which are repeated along and attached by braze welding or laser welding to the cutting edge, the segments of the first and the second plurality have corresponding thicknesses which are greater than the thickness of the support and the segments of the first plurality are thicker than the segments of the second plurality, and the abrasive material from which the segments of the first plurality are formed has a smaller particle size than the abrasive material from which the segments of the second plurality are formed.

14. The tool according to claim 13, in which the repeated sequence of segments along the cutting edge includes a segment of the first plurality positioned adjacent to a segment of the second plurality, all the segments of the sequence being aligned along the edge in the direction of cutting.

15. The tool according to claim 13, in which the repeated sequence of segments along the cutting edge includes a pair of adjacent segments of the first plurality located adjacent to a pair of segments of the second plurality, all the segments of the sequence being aligned along the edge in the direction of cutting.

16. The tool according to claim 13, in which the repeated sequence of segments along the edge includes a segment of one of the pluralities adjacent to a pair of segments of the other of the pluralities of segments, all the segments of the sequence being aligned along the edge in the direction of cutting.

17. A tool for cutting stone materials, porcelaneous stoneware, glass and the like in a direction of cutting, the tool comprising:
a disc-shaped support having a transverse thickness with respect to the direction of cutting and a circumferential cutting edge; and
abrasive segments attached to the support and made from a mixture of abrasive material including diamond powders and binder including powdered metals, the segments being positioned in sequence along the cutting edge of the support and projecting from the support, the segments having a first and a second plurality of segments in which one or more segments of the first plurality alternate with one or more segments of the second plurality in sequences which are repeated along and attached by braze welding or laser welding to the cutting edge, the segments of the first and the second plurality have corresponding thicknesses which are greater than the thickness of the support and the segments of the first plurality are thicker than the segments of the second plurality, the powdered metals of the segments of the first plurality have a different composition from that of the powdered metals of the segments of the second plurality, and the powdered metals of the segments of the first plurality have a smaller particle size from that of the powdered metals of the segments of the second plurality.

18. The tool according to claim 17, in which the repeated sequence of segments along the cutting edge includes a segment of the first plurality positioned adjacent to a segment of the second plurality, all the segments of the sequence being aligned along the edge in the direction of cutting.

19. The tool according to claim 17, in which the repeated sequence of segments along the cutting edge includes a pair of adjacent segments of the first plurality located adjacent to a pair of segments of the second plurality, all the segments of the sequence being aligned along the edge in the direction of cutting.

20. The tool according to claim 17, in which the repeated sequence of segments along the edge includes a segment of one of the pluralities adjacent to a pair of segments of the other of the pluralities of segments, all the segments of the sequence being aligned along the edge in the direction of cutting.
